(19) United States
(12) Patent Application Publication
(10) Pub. No.: US 2014/0139299 A1
(43) Pub. Date: May 22, 2014

(54) EMI Filter Assemblies For Busbars Of An UPS

(71) Applicant: Liebert Corporation, Columbus, OH (US)

(72) Inventor: Michael E. MILLER, Delaware, OH (US)

(21) Appl. No.: 14/078,909

(22) Filed: Nov. 13, 2013

Related U.S. Application Data
(60) Provisional application No. 61/729,047, filed on Nov. 21, 2012.

(51) Int. Cl. H03H 7/01

(52) U.S. Cl. CPC H01F 37/00; H01F 27/00
USPC 333/181; 336/185

(57) ABSTRACT

An electromagnetic interference (EMI) filter assembly includes an EMI core having a center opening. The EMI core is configured to prevent interference between busbars of an uninterruptible power supply. The EMI core surrounds members of the busbars. At least one bracket is disposed though the center opening and configured to hold the EMI core to the busbars. The at least one bracket includes flanges. The flanges include slots in which the EMI core is held. Spacers are disposed between the busbars. Fasteners connect the at least one bracket, the spacers, and the busbars to each other.

### CROSS-REFERENCE TO RELATED APPLICATIONS

This application claims the benefit of U.S. Provisional Application No. 61/729,047 filed on Nov. 21, 2012. The entire disclosure of the above application is incorporated herein by reference.

### FIELD

The present disclosure relates to generally uninterruptible power supplies (UPSs), and more particularly to electromagnetic interference (EMI) filters of UPSs.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Uninterruptible power supplies (UPSs) are used in supplying power to data centers. An electric utility substation downconverts utility power to generate substation power that is supplied to the UPSs, which condition the substation power. The UPSs provide back-up power to the data centers in the event of interruption of power from an electric utility and/or substation. Each of the UPSs may have a source of backup power. The UPSs may supply power to, for example, one or more power supplies of one or more servers of the data center.

A data center may have multiple loads (e.g., servers). Each of the loads has a power supply (load power supply) that may operate over a range of input voltages. One or more UPSs may be used to provide output voltage(s) to the load power supplies of the data center. The UPSs receive power from a substation at a substation voltage (e.g., 208 VAC) and may each be configured to provide output power at a fixed nominal output voltage. The UPSs may have an UPS mode and a bypass mode. When in the UPS mode, the UPSs may regulate, filter and condition a substation voltage to provide the output power.

Each of the UPSs may include a bypass switch that, when in the bypass mode, is in a bypass state (e.g., closed). The power from the utility at the substation voltage is provided directly to the load power supplies when the UPS is in the bypass mode without regulating, filtering and/or conditioning the substation voltage. This may be performed when a failure occurs in the UPS or the input power from the utility is clean enough that conditioning is not required. In the bypass mode, components (e.g., transformers, rectifier(s), inverter(s), etc.) of the UPS are bypassed to provide the power from the utility at the substation voltage directly to the output of the UPS and thus directly to the load power supplies.

An UPS can include a utility input, a rectifier, an inverter, a bypass circuit and an output. Utility power is provided to the utility input. When in the UPS mode, the power is conditioned via the rectifier and inverter prior to being provided to the output. When in the bypass mode, the power is directly provided to the output via the bypass circuit.

The utility power is provided from the utility input to the bypass circuit and from the bypass circuit to the output via busbars. An EMI filter may be connected between the utility input and the bypass circuit of the UPS to absorb EMI emitted by the busbars. The EMI filter may include EMI cores. The busbars extend through the EMI cores. A metal hanger may be mounted on a frame of the UPS above the busbars and be connected to the EMI cores. The EMI cores are ring-shaped to satisfy EMI, airflow and cooling requirements.

During operation of the UPS, a fault associated with the utility power can cause the busbars to move. Because of this movement, the busbars may come in contact with and damage the EMI cores. As a result, the EMI cores may break into multiple pieces, which may contact multiple busbars and/or other circuit components, such as the bypass switch. This can cause short circuits between electrical components in the UPS.

One technique to prevent short circuits between the busbars is to cover the busbars with insulation to prevent pieces of the EMI cores from coming in contact with the busbars. Although this reduces the number and/or chances of short circuits during a utility power fault condition, the insulation has associated disadvantages. Use of the insulation results in increased operating temperatures of UPS components. In addition, the material and labor costs associated with manufacturing an UPS are increased in order to include the insulation.

### SUMMARY

An electromagnetic interference (EMI) filter assembly is provided and includes an EMI core having a center opening. The EMI core is configured to prevent interference between busbars of an uninterruptible power supply. The EMI core surrounds members of the busbars. At least one bracket is disposed though the center opening and configured to hold the EMI core to the busbars. The at least one bracket includes flanges. The flanges include slots in which the EMI core is held. Spacers are disposed between the busbars. Fasteners connect the at least one bracket, the spacers, and the busbars to each other.

In an aspect, the at least one bracket includes only a single bracket. In another aspect, the single bracket includes: a center member disposed between a first two of the busbars and a second two of the busbars; a first flange that extends over the first two of the busbars; and a second flange that extends over the second two of the busbars.

In another aspect, the first flange and the second flange are on opposite sides and opposite ends of the center member and extend away from the center member in opposite directions. In another aspect, the first flange includes a first member and a second member. The second flange includes a third member and a fourth member.

In another aspect, the slots include a first slot and a second slot. The first member and the second member provide the first slot. The third member and the fourth member provide the second slot. The EMI core is held in the first slot and the second slot. In other features, the first flange includes a first angled section between the center member and the first member. A second angled section is between the first member and the second member. The second flange includes a third angled section between the center member and the third member. A fourth angled section is between the third member and the fourth member.

In another aspect, the at least one bracket has an uncompressed state and a first compressed state. The first flange is configured to rotate towards the center member via the first angled second and the second angled section when being transitioned from the uncompressed state to the first compressed state. The second flange is configured to rotate towards the center member via the third angled second and the fourth angled section when being transitioned from the uncompressed state to the first compressed state.

In another aspect, the EMI bracket is configured to be in a second compressed state. The first flange and the second flange are in the first compressed state during installation of the EMI core on the at least one bracket. The first flange and the second flange are in the second compressed state subsequent to installation of the EMI core on the at least one bracket.

In another aspect, the at least one bracket includes a first bracket and a second bracket. The first bracket and the second bracket are outward facing brackets such that center members of the first bracket and the second bracket pass through a center of the EMI core.

In another aspect, the first bracket includes first flanges. The second bracket includes second flanges. The first flanges extend from the center member and in an opposite direction as the second flanges. In another aspect, the spacers include first spacers disposed on an outermost side of a first busbar and second spacers disposed on an outermost side of a second busbar. The first flanges extend over a first pair of the busbars and are in contact with the first spacers. The second flanges extend over a second pair of the busbars and are in contact with the second spacers. In another aspect, members of a first two of the busbars are disposed between the first flanges. Members of a second two of the busbars are disposed between the second flanges.

In another aspect, each of the first flanges and each of the second flanges includes a compression slot. The first flanges are rotated toward each other via respective ones of the compression slots. The second flanges are rotated toward each other via respective ones of the compression slots.

In another aspect, the at least one bracket includes a first bracket and a second bracket. The first bracket and the second bracket are inward facing brackets such that all of the busbars are disposed between the first bracket and the second bracket.

In another aspect, the first bracket includes first flanges. The second bracket includes second flanges. The first flanges extend from a center member of the first bracket and towards the second flanges. In another aspect, outermost ones of the busbars are disposed respectively between the first flanges or the second flanges. Innermost ones of the busbars are not disposed between the first flanges or between the second flanges.

In another aspect, each of the fasteners includes an element that extends through the at least one bracket, the busbars, and the spacers. In another aspect, the at least one bracket prevents the EMI core from contacting the busbars and allows the EMI core to move with the busbars.

In another aspect, an EMI bracket is provided and includes a center member includes holes for attaching fasteners to connect the EMI bracket to busbars of an uninterruptible power supply. Flanges configured to hold an annular-shaped EMI core on the busbars. The center member and the flanges prevent the annular-shaped EMI core from contacting the busbars and allow the annular-shaped EMI core to move with the busbars.

In another aspect, the flanges include a first flange having a first member and a second member. The first member and the second member provide a first slot. A second flange includes a third member and a fourth member. The third member and the fourth member provide a second slot. The first slot and the second slot are configured to hold the annular-shaped EMI core.

In another aspect, the first flange includes a first angled section between the center member and the first member and a second angled section between the first member and the second member. The second flange includes a third angled section between the center member and the third member and a fourth angled section between the third member and the fourth member.

In another aspect, the EMI bracket has an uncompressed state and a first compressed state. The first flange is configured to rotate towards the center member via the first angled second and the second angled section when being transitioned from the uncompressed state to the first compressed state. The second flange is configured to rotate towards the center member via the third angled section and the fourth angled section when being transitioned from the uncompressed state to the first compressed state.

In another aspect, the EMI bracket is configured to be in a second compressed state. The first flange and the second flange are in the first compressed state during installation of the annular-shaped EMI core on the at least one bracket. The first flange and the second flange are in the second compressed state subsequent to installation of the annular-shaped EMI core on the at least one bracket.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an UPS system in accordance with an aspect of the present disclosure;

FIG. 2 is a functional block diagram of a bypass circuit in accordance with an aspect of the present disclosure;

FIG. 3 is a schematic diagram of the bypass circuit of FIG. 2;

FIG. 4 is an isometric view of an EMI filter assembly incorporating outwardly opposing EMI brackets in accordance with an aspect of the present disclosure;

FIG. 5 is an end view of the EMI filter assembly of FIG. 4;

FIG. 6 is an isometric view of an EMI bracket having quad-compression slots in accordance with an aspect of the present disclosure;

FIG. 7 is a perspective view of another EMI bracket having dual-compression slots in accordance with an aspect of the present disclosure;

FIG. 8 is an isometric view illustrating states of EMI brackets in accordance with an aspect of the present disclosure;

FIG. 9 is an end view of another EMI filter assembly incorporating a single EMI bracket in accordance with an aspect of the present disclosure;

FIG. 10 is an isometric view of the EMI bracket and EMI cores of the EMI filter assembly of FIG. 9;

FIG. 11 is an isometric view of an EMI filter assembly incorporating inwardly opposing EMI brackets in accordance with an aspect of the present disclosure; and

FIG. 12 is an end view of the EMI filter assembly of FIG. 11.

### DETAILED DESCRIPTION

EMI filter assembly implementations are disclosed herein that suspend EMI cores around busbars, while preventing the EMI cores from coming in contact with the busbars. The EMI cores are prevented from coming in contact with the busbars during movement of the busbars during a utility power fault condition. The techniques allow the busbars to move within the EMI cores, while preventing the busbars from contacting each other. This prevents short circuits between busbars and between other components of an UPS. The implementations also eliminate the need for hangers and/or other components previously used to mount and hold EMI cores.

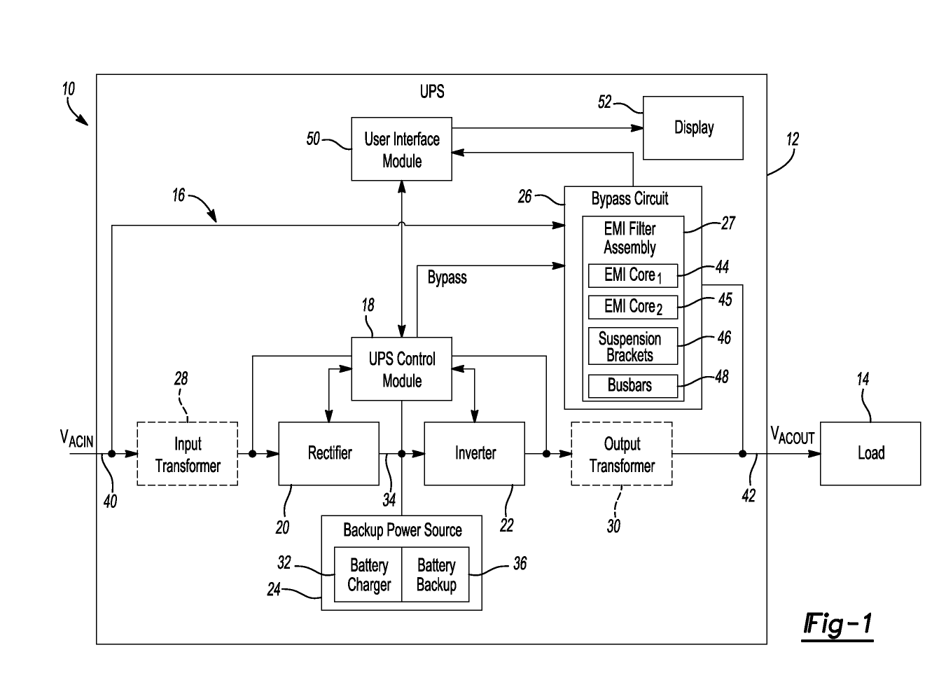

In FIG. 1, an UPS system 10 is shown. The UPS system 10 may include one or more UPSs (one UPS 12 is shown) that supply AC power to one or more loads (one load 14 is shown). Each of the UPSs may supply power to one or more loads. The UPSs 10 may be connected in parallel to provide more power capacity. The load(s) may include, for example, one or more server power supplies, network switches and devices, telecommunication switches and devices, audio/video hubs and devices, air conditioning units, medical devices and equipment, industrial devices and equipment, etc.

The UPS 12 includes an UPS power circuit 16 and an UPS control module 18. The UPS power circuit 16 includes a rectifier 20 and an inverter 22. UPS 12 also includes a backup power source 24 and a bypass circuit 26. The bypass circuit 26 includes an EMI filter assembly 27 that absorbs EMI emitted by busbars of the bypass circuit 26. Examples of busbars are shown in FIGS. 3-5, 9, and 11-12. The UPS power circuit 16 may also include an input transformer 28 and/or an output transformer 30, as shown. The UPS 12 may not include the transformers 28, 30. The UPS control module 18 may include a digital signal processor with embedded software that detects current, voltage and power parameters in the UPS power circuit 16. The UPS control module 18 monitors inputs and outputs of devices in UPS 12, and controls operation of the UPS power circuit 16, backup power source 24, and bypass circuit 26 based on the inputs and outputs.

The UPS control module 18 may control operation of rectifiers, inverters, transformers, chargers and other circuit elements of the UPS power circuit 16, such as switching power devices (not shown). The UPS control module 18 may, for example: select and set a mode of operation and maintain voltage and current levels at the output of the UPS 12 and thus on the load 14. The UPS control module 18 may also provide limits (e.g., limiting current supplied to the load 14), set fault conditions, set event conditions, and set alarm conditions and control operation of the UPS 12 based on these conditions.

The rectifier 20, the inverter 22 and the transformers 28, 30 are connected in series between a main AC source (e.g., substation voltage source, regulated utility power source, generator, fuel cell, etc.) and the load 14. The main AC source supplies AC power to the input transformer 28, which in turn supplies AC power to the rectifier 20. The rectifier 20 functions as an AC/DC converter and converts AC to DC, which is provided to a DC bus 34. The DC bus 34 is coupled to an output of rectifier 20 and to an input of the inverter 22. The inverter 22 functions as a DC/AC converter and converts DC on the DC bus 34 to AC that is provided at an output of the inverter 22. The backup power source 24 provides power for the load 14 (for example, by providing a backup source of DC) when power from the main AC source is lost or is sufficiently degraded (e.g., improper voltage level, improper current levels, etc.) such that it can't be used. The backup power source 24 may include one or more of a backup battery (which may be a battery bank), a flywheel, a fuel cell, etc.

When the UPS 12 is operating in the UPS mode, power is supplied to the load 14 from the main AC source through the rectifier 20 and the inverter 22. This provides regulated and filtered power with minimal irregularities, such as voltage spikes, frequency deviations or phase deviations. In one circuit topology, the rectifier 20 provides power to the inverter 22 and to a battery charger 32 of the backup power source 24 via a DC bus 34. The rectifier 20 may be a pulse width modulated (PWM) rectifier. The battery charger 32 charges, for example, battery backup 36. In another topology, when the battery backup is directly connected to the DC bus 34, the rectifier 20 may be a phase controlled rectifier and used to charge the battery backup without use of a separate battery charger.

Continuing from the same example, when power from the main AC source is interrupted, the UPS 12 switches to a back-up mode and power is supplied from the backup power source 24 to the inverter 22 instead of from the main AC source. This allows power to be maintained on the load 14 without interruption. When the battery backup 36 is directly connected to the DC bus 34 and when the power from the main AC source is interrupted, power is supplied directly from the battery backup 36 to the DC bus 34 and not through the rectifier 20. The described UPS 12 provides uninterruptible clean AC power. The voltage provided to the load 14 is regulated. The voltage provided to the DC bus 34 by the battery backup 36 may not be regulated and decreases as energy is drawn from the battery backup 36.

The input transformer 28 may isolate the main AC source from the rectifier 20. The rectifier 20 may directly receive power from the main AC source having a first AC voltage V_{ACIN}. The first AC voltage V_{ACIN} may be referred to as the static bypass voltage. The input transformer 28 may convert the first AC voltage V_{ACIN} to a transformer supply voltage (second AC voltage V_{RECTIN}). The second AC voltage V_{RECTIN} may be less than or equal to the first AC voltage V_{ACIN}. The input transformer 28 may include one or more filters and/or cancel certain harmonics in the power from the main AC source. The rectifier 20 converts the second AC voltage (or transformer supply voltage) V_{RECTIN} from the input transformer 28 to a DC bus voltage V_{RECTOUT}, which is provided to the DC bus 34.

The inverter 22 converts the DC bus voltage V_{RECTOUT} (or V_{INVIN}) on the DC bus 34 to a third AC voltage V_{INVOUT}. The third AC voltage V_{INVOUT} may be less than or equal to the first AC voltage V_{ACIN} and equal to the second AC voltage V_{RECTIN}. The third AC voltage V_{INVOUT} may be provided to the output transformer 30. The output transformer 30 converts the third AC voltage V_{INVOUT} to an AC output voltage (fourth AC voltage) V_{ACOUT}, which is provided to the load 14.

The UPS 12 may operate in a bypass mode. When in the bypass mode, the control module 18 may signal the bypass circuit 26 to be in its bypass state via one or more bypass control signals BYPASS. The bypass circuit 26 is connected in parallel with the input transformer 28, the rectifier 20, the inverter 22, and the output transformer 30. The bypass circuit 26 is connected to an input 40 of the UPS 12 and/or the input transformer 28 and to an output 42 of the UPS 12 and/or the output transformer 30 and receives utility power. While in the bypass state, the bypass circuit 26 provides AC power having the first AC voltage V_{ACIN} directly from the main AC source to the output 42 of UPS 12 and thus directly to the load 14. As a result, the input transformer 28, the rectifier 20, the inverter 22, and the output transformer 30 are bypassed. It should be understood that the bypass circuit 26 could be coupled to a source of AC power other than the source connected to the input of the UPS 12.

When the UPS 12 is in the UPS mode, the UPS control module 18 controls the bypass circuit 26 to be in its non-bypass state and AC power is thus not provided directly from the main AC source to the output 42 of the UPS 12. The load 14 is provided power via the rectifier 20, the inverter 22, and the transformers 28, 30.

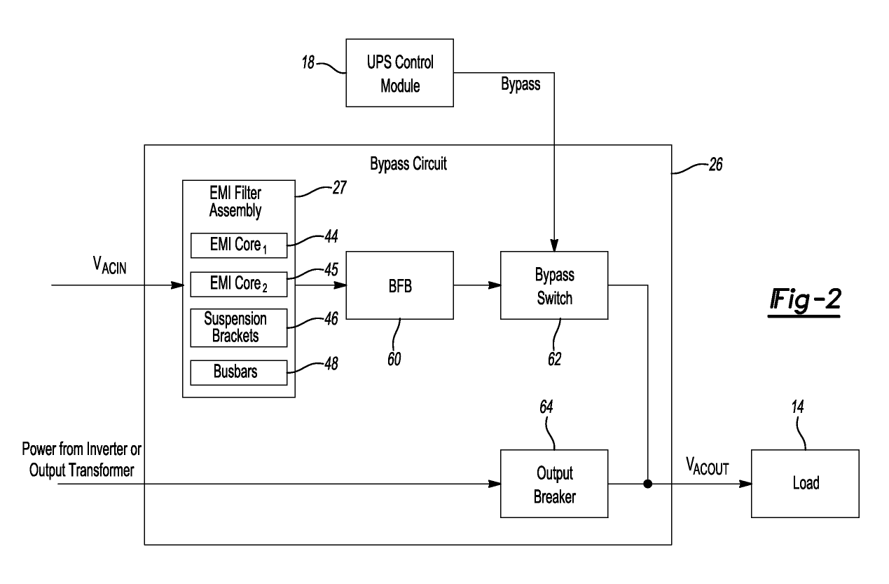

The bypass circuit 26 includes the EMI filter assembly 27, which includes EMI cores 44, 45 and one or more EMI suspension brackets (hereinafter EMI brackets) 46. Although two EMI cores are shown, any number of EMI cores may be included. Examples of the EMI filter assembly 27, the EMI cores 44, 45 and the EMI brackets 46 are shown in FIGS. 2-12. The EMI cores 44, 45 absorb EMI emitted by busbars 48 of the bypass circuit 26. The EMI cores 44, 45 surround the busbars 48 and are suspended on the busbars 48 via the EMI brackets 46. This is further described below.

The UPS 12 may also include a user interface module 50 that is in communication with the UPS control module 18 and provides input settings for system parameters. The user interface module 50 may be used to set voltage levels, current limitations, and power limitations for the devices 20, 22, 28, 30 of the UPS 12 and the AC load 14. Current and voltage levels in and out of, for example the rectifier 20, the inverter 22, and the output transformer 30 may be regulated, monitored, adjusted, and limited separately and/or independently of each other or in a dependent manner. The user interface module 50 may also be used to select automatic and manual operating modes. During the automatic mode, the UPS control module 18 may select the bypass mode and the UPS mode (normal or adaptive voltage control mode) based on states (e.g., input and output current and voltage levels) of the rectifier 20, the inverter 22 and/or the output transformer 30. During the manual mode, a user may manually select the bypass mode and the UPS mode (normal or adaptive voltage control mode).

The UPS 12 may also include a display 52, which may be used to indicate the voltage, current, and power statuses of the inputs and outputs of various devices of the UPS 12. A user may perform appropriate tasks based on the displayed information including selecting the automatic, manual, bypass, and UPS modes.

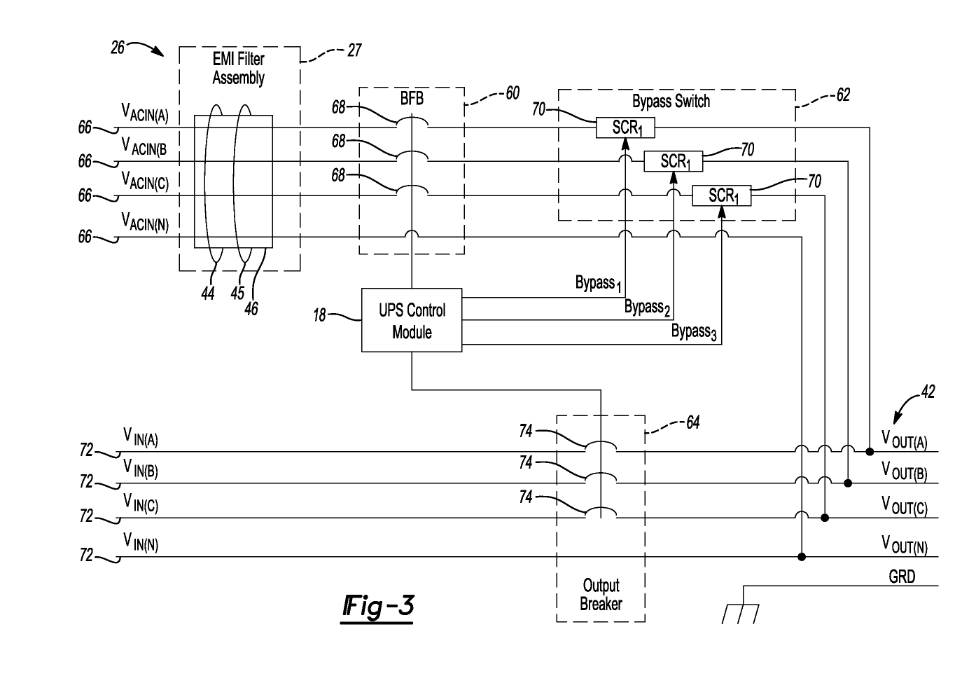

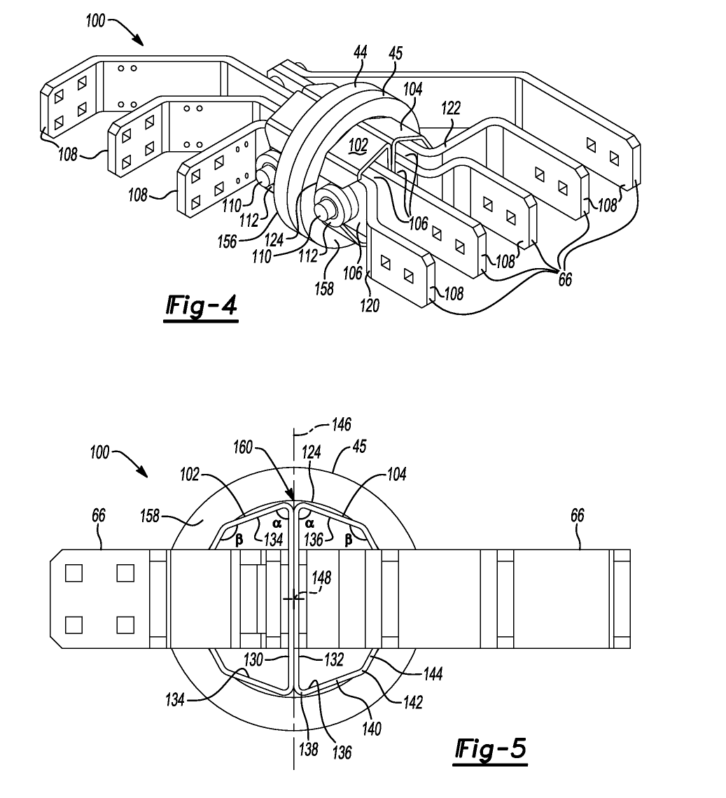

Referring now also to FIGS. 2-3, the bypass circuit 26 is shown. The bypass circuit 26 includes the EMI filter assembly 27, a bypass backfeed breaker (BFB) 60, a bypass switch 62, and an output breaker 64. The EMI filter assembly 27 includes the EMI cores 44, 45 and the EMI brackets 46. Busbars 66 are disposed through the EMI cores 44, 45 such that the EMI cores 44, 45 surround the busbars 66. Examples of the busbars 66 are further shown in FIGS. 4-5, 9 and 11-12. The first AC voltage V_{ACIN} having phases A-C (identified as V_{ACIN(A-C)}) and neutral N (identified as V_{ACIN(N)}) is received by the EMI filter assembly 27 and provided to the BFB 60.

The BFB 60 prevents leakage current through the bypass switch 62 during a utility power fault condition, such as an outage of the utility power. The BFB 60 may include a relay with contacts 68, which may be opened or closed by the UPS control module 18. The UPS control module 18 may close the contacts 68 when operating in the bypass mode and open the contacts when operating in the UPS mode.

The bypass switch 62 may include silicon-controlled rectifiers (SCRs) 70 and other suitable components, which may operate as switches for respective phases of AC power received from the BFB 60 on the busbars 66. The SCRs 70 may include ON (OPEN or reduced conduction) and OFF (CLOSED or conducting) states and be controlled by the UPS control module 18. The UPS control module 18 may switch the SCRs 70 to the OFF state when operating in the bypass mode and to the ON state when operating in the UPS mode. The UPS control module 18 may generate respective bypass signals BYPASS₁₋₃, which may be received by the SCRs 70 and control the states of the SCRs 70. Power may be provided from the busbars 66 to the output 42 when the contacts 68 of the BFB 60 and the SCRs 70 are in closed states.

Busbars 72 may be connected between (i) the inverter 22 or the output transformer 30, and (ii) the output 42. The busbars 72 may receive AC power from the inverter 22 or the output transformer 30 identified as V_{INV(A-C)} and V_{INV(N)}. The output breaker 64 may be connected to the busbars 72 and be used to interrupt power on the busbars 72 including phases (A-C) and/or neutral N of the AC power from being received at the output 42. The output breaker 64 may include a relay with contacts 74, which may be opened or closed by the UPS control module 18. The UPS control module 18 may open the contacts 74 when operating in the bypass mode and close the contacts 74 when operating in the UPS mode.

In FIGS. 4-5, an EMI filter assembly 100 is shown. The EMI filter assembly 100 may be used in replacement of the EMI filter assembly 27 of FIGS. 1-3. The EMI filter assembly 100 includes the EMI cores 44, 45, the busbars 66, and EMI brackets 102, 104. The EMI cores 44, 45 are annular-shaped and may be formed of ferrite and/or other suitable materials capable of withstanding temperatures greater than a predetermined temperature.

The busbars 66 include suspended members 106 and flanges 108. The suspended members 106 are suspended and are disposed through the EMI cores 44, 45 and the EMI brackets 102 without contacting the EMI cores 44, 45 and/or the EMI brackets 102, 104. When installed, two of the busbars 66 may be disposed through the first EMI bracket 102 and the other two of the busbars 66 may be disposed through the second EMI bracket 104. The busbars 66 are connected to each other and the EMI brackets 102, 104 via fasteners 110 and spacers 112.

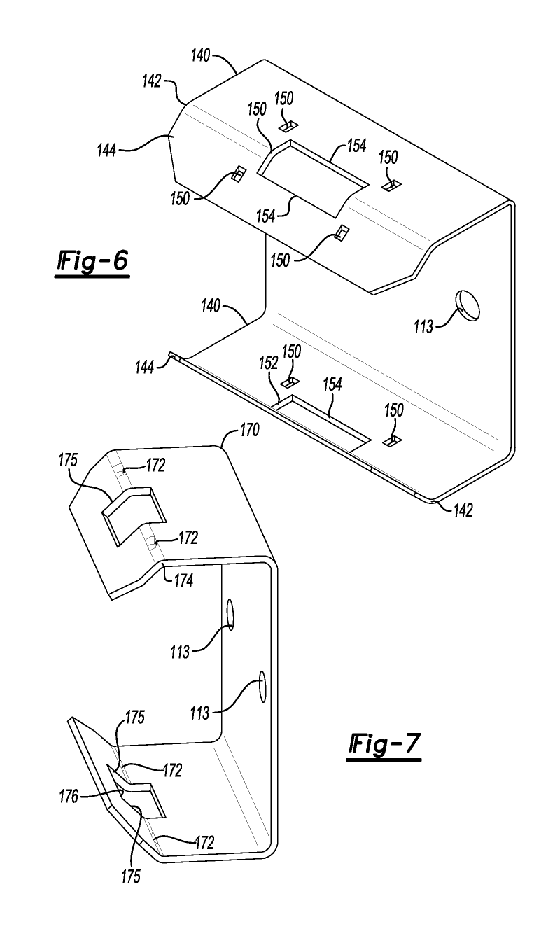

Each of the fasteners 110 may include a first element (e.g., a threaded rod) and one or more second elements (e.g., nuts and/or washers). For example only, during installation, two threaded rods are pushed through respective holes (example holes 113 are shown in FIGS. 6-7) in the busbars 66, the EMI brackets 102, 104, and the spacers 112. The washers are then slid onto the threaded rods. The nuts are then screwed onto the threaded rods. The nuts may be screwed onto the threaded rods to satisfy predetermined torque settings.

The threaded rods may each be covered with an insulating tube (not shown). The insulating tubes may be slid over the threaded rods. The threaded rods and the insulating tubes may be slid through the respective holes in the busbars 66, the EMI brackets 102, 104, and the spacers 112 prior to installing the washers and nuts on the threaded rods. The insulating tubes may isolate and/or prevent contact between the busbars 66 and the threaded rods. As an alternative to using the insulating tubes, the threaded rods may be coated or rapped with an insulating material. As an example, the threaded rods may be formed of stainless steel and/or other suitable materials.

The spacers 112 may be located between the busbars 66 and on each side of each of the busbars 66 including outermost busbars 120, 122 (or busbars closest to the EMI cores 44, 55). The spacers 112 on the outermost busbars 120, 122 and closest to the EMI cores 44, 45 aid in preventing the fasteners 110 and/or hardware associated therewith from contacting the outermost busbars 120, 122. The spacers 112 may be, for example, washers formed of fiberglass reinforced polyester and/or other suitable insulative and/or non-conductive materials. The flanges 108 may each be connected to other busbars and/or other respective components of the UPS 10 of FIG. 1.

The EMI brackets 102, 104 are symmetric and may be used in replacement of the EMI brackets 46 of FIGS. 1-3. The EMI brackets 102, 104 are two outwardly opposing brackets that are concave-shaped. Each of the brackets 102, 104 is positioned in an inner perimeter 124 of the EMI cores 44, 45 and is disposed through the EMI cores 44, 45. Each of the EMI brackets 102, 104 includes a center member 130, 132 and a pair of flanges 134, 136. Each of the suspended members 106 of the busbars 66 are disposed between flanges 134 or 136 of a corresponding one of the EMI brackets 102, 104.

Each of the flanges 134, 136 includes a first angled section 138, a first member 140, a second angled section 142, and a second member 144. Angled sections disclosed herein may be referred to as being bent. The first member 140 extends at a first angle α from the center members 130, 132 and away from a centerline 146 (a single centerline is shown) of each of the EMI cores 44, 45. The first angle α is provided by the first angled section 138. The centerlines pass through centers of the EMI cores 44, 45. The centers of the EMI cores 44, 45 are shown as a center point 148 within the inner perimeters 124 of the EMI cores 44, 45. The second member 144 extends at a second angle β from the first member 140 and away from the centerline 146. The second angle β may be greater than the first angle α. The second angle β is provided by the second angled section 142.

The EMI brackets 102, 104 may be formed of, for example, polycarbonate resin thermoplastic and/or other suitable materials that have similar flexing and bending properties and are capable of withstanding temperatures greater than a predetermined temperature. The EMI brackets 102, 104 may be formed of insulative, transparent and/or non-conductive materials. The EMI brackets 102, 104 may be non-conductive.

Referring now also to FIG. 6, one of the EMI brackets 102, 104 of FIGS. 4 and 5 is shown having quad-compression slots 150. Although one of the EMI brackets 102, 104 is shown in FIG. 6, the other one of the EMI brackets 102, 104 may be the same or similar to the EMI bracket shown. The flanges 134, 136 of the EMI brackets 102, 104 may include core slots 152 and the compression slots 150. When the EMI cores 44, 45 are installed on the EMI brackets 102, 104, the EMI cores 44, 45 are held in the core slots 152. The first and second members 140, 144 may each include a notch 154, which together form one of the core slots 152.

The core slots 152 provide multiple points along the inner perimeters 124 of the EMI cores 44, 45 at which the EMI cores 44, 45 are held by the EMI brackets 102, 104. The core slots 152 are located such that the second angled section 142 in the EMI brackets 102, 104 includes and/or abuts portions of a respective one of the core slots 152. This allows the first and second members 140, 144 and/or the second angled sections 142 near the core slots 152 to extend over opposing sides 156, 158 of the EMI cores 44, 45 when the EMI cores 44, 45 are installed. An example of this is shown in FIG. 5. By the first and second member 140, 144 extending over the opposing sides 156, 158 of the EMI cores 44, 45, the EMI cores 44, 45 are prevented from moving along the EMI brackets 102, 104. Also, as the EMI brackets 102, 104 are in a compressed state subsequent to the EMI cores 44, 45 being installed, the EMI brackets 102, 104 are further prevented from moving relative to the EMI cores 44, 45. As a result, the EMI cores 44, 45 move with the EMI brackets 102, 104. The EMI cores 44, 45 may be able to rotate on the EMI brackets 102, 104 depending upon (i) the amount of clearance between the EMI cores 44, 45 and the core slots 152, and/or (ii) an amount of pressure applied by the flanges 134, 136 against the EMI cores 44, 45 due to compression of the flanges 134, 136.

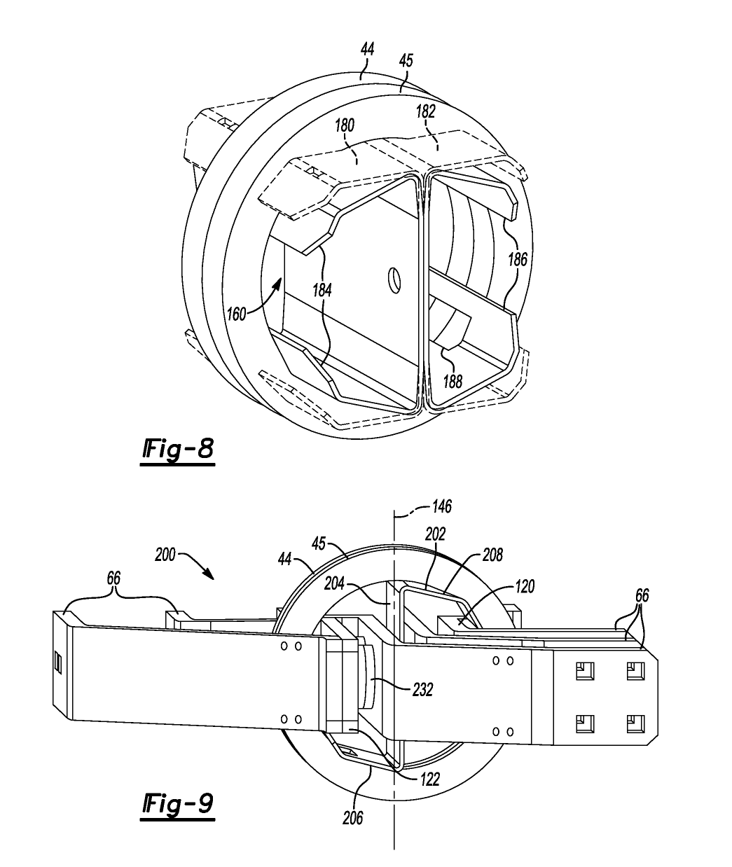

The compression slots 150 may be used to compress or bend the flanges 134, 136 of each of the EMI brackets 102, 104 from an uncompressed state to a first compressed state. The center members 130, 132 may flex and/or the flanges 134, 136 may flex at the angled sections 138, 142 to allow the flanges 134, 136 of each of the EMI brackets 102, 104 to be compressed and rotated towards each other and towards the center members 130, 132 during installation of the EMI cores 44, 45. Examples of compressed and non-compressed states of flanges are shown in FIG. 8. The flanges 134, 136 of each of the EMI brackets 102, 104 are rotated towards each other to allow the EMI brackets 102, 104 to fit through a circular opening 160 in the EMI cores 44, 45. This allows the EMI cores 44, 45 to be slid over the EMI brackets 102, 104 to be positioned in the core slots 152. The flanges 134, 136 may then be released to a second compressed state. Examples of uncompressed and second compressed states are shown in FIG. 8.

For example only, zip-ties (not shown) or other suitable fastener may be passed through the compression slots 150 of opposing flanges (e.g., flanges 134 or 136). Ends of each of the zip-ties may be locked together. The zip-ties may be tightened to move the opposing flanges towards each other until second angled sections (e.g., angled sections 142) clear the inner perimeters 124 of the EMI cores 44, 45. Subsequent to installing the EMI cores 44, 45 on the EMI brackets 102, 104, the zip-ties may then be cut to release the opposing flanges to the second compressed state. The use of zip-ties to compress opposing flanges is provided as an example, other techniques may be used to compress the flanges 134, 136 for installation of the EMI cores 44, 45.

The flanges 134, 136 may include any number of compression slots. In FIG. 6, each of the flanges (e.g., one of the flanges 134, 136) includes four compression slots 150. Each of the compression slots 150 is located on one of the first and second members 140, 144. In the example show, two compression slots are located on each of the first and second members 140, 144. In FIG. 7, an EMI bracket 170 is shown having dual-compression slots 172. The compression slots 172 are located on second angled sections 174 and on opposite sides 175 of a core slot 176.

In FIG. 8, EMI brackets 180, 182 are shown in different states. The EMI brackets 180, 182 may replace the EMI brackets 46 of FIGS. 1-3. The EMI brackets 180, 182 may be in an uncompressed state, a first compressed state and a second compressed state. The uncompressed state is shown with dashed lines and the second compressed state is shown with solid lines. Although the uncompressed state is shown with the EMI cores 44, 45 installed on the brackets 180, 182, the uncompressed state is shown for comparison purposes only. The EMI brackets 180, 182 are not in the uncompressed state when the EMI cores 44, 45 have been installed on the EMI brackets 180, 182, but rather are in the second compressed state. The EMI brackets 180, 182 are in the uncompressed state prior to installing the EMI cores 44, 45 on the EMI brackets 180, 182.

The second compressed state may have an associated lesser degree of compression than the first compressed state. The EMI brackets 180, 182 may be in the first (or fully) compressed state during installation of the EMI cores 44, 45. During installation, flanges 184, 186 of each of the EMI brackets 180, 182 may be rotated inward toward each other when compressed to the first compressed state. The EMI brackets 180, 182 may then be slid through the EMI cores 44, 45 until the EMI cores 44, 45 are over core slots 188 in the EMI brackets 180, 182. Subsequent to the EMI cores 44, 45 being installed on the EMI brackets 180, 182, the flanges 184, 186 may then be released to the second (or partially) compressed state.

As an alternative, the EMI brackets 180, 182 may include an uncompressed state and a compressed state. The EMI brackets 180, 182 may be in the uncompressed state prior to installation of the EMI cores 44, 45 and subsequent to installation of the EMI cores 44, 45. The EMI brackets 180, 182 may be in the compressed state during installation of the EMI cores 44, 45.

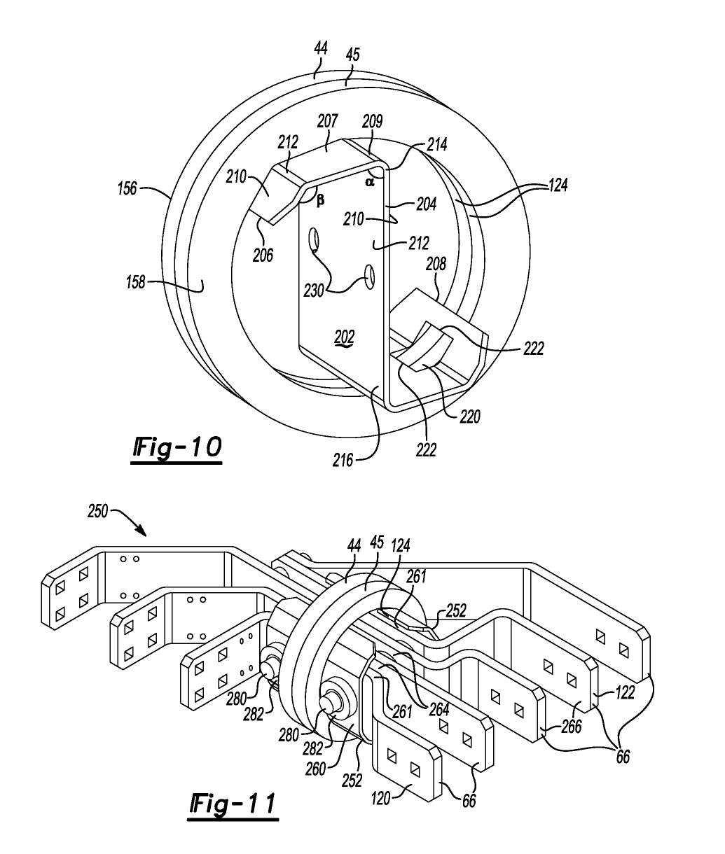

In FIGS. 9-10, an EMI filter assembly 200 is shown having a single EMI bracket 202. The EMI filter assembly 200 may be used in replacement of the EMI filter assembly 27 of FIGS. 1-3. The EMI filter assembly 200 includes the EMI cores 44, 45, the EMI bracket 202, and the busbars 66. The EMI bracket 202 may be used in replacement of the EMI brackets 46 of FIGS. 1-3. The EMI bracket 202 includes a center member 204 that is disposed along the centerlines (the single centerline 146 is shown) of the EMI cores 44, 45 when the EMI cores 44, 45 are installed on the EMI bracket 202. The EMI bracket 202 includes two flanges 206, 208 that are on opposite sides 210, 212 and opposite ends 214, 216 of the center member 204 and extend away from the center member 204 in opposite directions.

Each of the flanges 206, 208 includes a first member 207, a first angled section 209, a second member 210 and a second angled section 212. The first member 207 extends at the first angle α from the center member and away from the centerlines of each of the EMI cores 44, 45. The first angle α is provided by the first angled section 209. The second member 210 extends at the second angle β from the first member 207 and away from the centerline 146 and/or center member 204. The second angle β may be greater than the first angle α. The second angle β is provided by the second angled section 212.

The flanges 206, 208 may include core slots (one core slot 220 is shown). When the EMI cores 44, 45 are installed on the EMI bracket 202, the EMI cores 44, 45 are held in the core slots 220. The first and second members 207, 210 of each of the flanges 206, 208 may each include a notch 222, which together form one of the core slots. The core slots are located such that the second angled sections 212 in the EMI bracket 202 between the first and second members 207, 210 includes and/or abuts portions of a respective one of the core slots 220. This allows the first and second members 207, 210 and/or the second angled sections 212 near the core slots 220 to extend over the opposing sides 156, 158 of the EMI cores 44, 45 when the EMI cores 44, 45 are installed.

The core slots 220 provide multiple points along the inner perimeters 124 of the EMI cores 44, 45 at which the EMI cores 44, 45 are held by the EMI bracket 202. By the first and second member 207, 210 extending over the opposing sides 156, 158, the EMI cores 44, 45 are prevented from moving along the EMI bracket 202. Also, as the EMI bracket 202 is in a compressed state subsequent to the EMI cores 44, 45 being installed, the EMI bracket 202 is prevented from moving relative to the EMI cores 44, 45. As a result, the EMI cores 44, 45 move with the EMI bracket 202. The EMI cores 44, 45 may be able to rotate on the EMI bracket 202 depending upon (i) the amount of clearance between the EMI cores 44, 45 and the core slots 220, and/or (ii) an amount of pressure applied by the flanges 206, 208 against the EMI cores 44, 45 due to compression of the flanges 206, 208.

The EMI bracket 202 may be formed of, for example, polycarbonate resin thermoplastic and/or other suitable materials that have similar flexing and bending properties and are capable of withstanding temperatures greater than a predetermined temperature. The EMI bracket 202 may be formed of insulative, transparent and/or electrically non-conductive materials. The EMI bracket 202 may be non-conductive.

The flanges 206, 208 are in an uncompressed state prior to installation of the EMI cores 44, 45 on the EMI bracket 202. The EMI bracket 202 may be compressed to rotate the flanges 206, 208 towards each other and towards the center member 204 to a first compressed state during installation of the EMI cores 44, 45. Once the EMI cores 44, 45 are installed, the flanges 206, 208 may be released to a second compressed state or the uncompressed state.

When installed, two of the busbars 66 may be on the first side 210 of the center member 204 and the other two of the busbars 66 may be on the second side 212 of the center member 204. The first flanges 206 may extend over the busbars 66 on the first side 210 of the center member 204. The second flange 208 may extend over the busbars 66 on the second side 212 of the center member 204.

The EMI bracket 202 may include holes 230 for insertion of threaded rods or other fasteners for fastening spacers (spacers 232 are shown) and the busbars 66 similar to that described with respect to the EMI brackets 102, 104, busbars 66, and spacers 112 of FIG. 4. As shown, the busbars 66 may be connected to each other and the EMI bracket 202 via fasteners and spacers. Each of the fasteners may include a first element (e.g., a threaded rod) and one or more second elements (e.g., nuts and/or washers). For example only, during installation, two threaded rods are pushed through respective holes in the busbars 66, the EMI bracket 202, and the spacers. The washers are then slid onto the threaded rods. The nuts are then screwed onto the threaded rods. The nuts may be screwed onto the threaded rods to satisfy predetermined torque settings.

The threaded rods may each be covered with an insulating tube (not shown). The insulating tubes may be slid over the threaded rods. The threaded rods and the insulating tubes may be slid through the respective holes in the busbars 66, the EMI bracket 202, and the spacers prior to installing the washers and nuts on the threaded rods. The insulating tubes may isolate and/or prevent contact between the busbars 66 and the threaded rods. As an alternative to using the insulating tubes, the threaded rods may be coated or rapped with an insulating material. As an example, the threaded rods may be formed of stainless steel and/or other suitable materials.

The spacers may be located between the busbars 66 and on each side of each of the busbars 66 including the outermost busbars 120, 122. The spacers on the outermost busbars 120, 122 closest to the EMI cores 44, 45 aid in preventing the fasteners from contacting the outermost busbars 120. The spacers may be, for example, washers formed of fiberglass reinforced polyester and/or other suitable insulative and/or non-conductive materials.

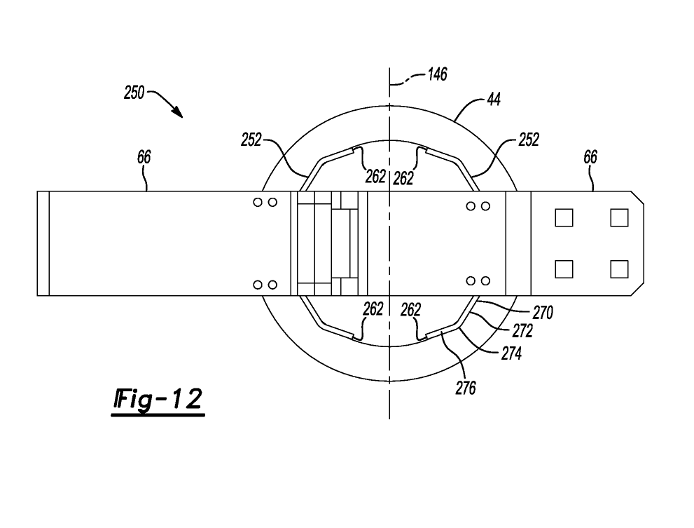

In FIGS. 11-12, an EMI filter assembly 250 is shown. The EMI filter assembly 250 may be used in replacement of the EMI filter assembly 27 of FIGS. 1-3. The EMI filter assembly 250 includes the EMI cores 44, 45, the busbars 66, and EMI brackets 252. The EMI brackets 252 are inwardly opposing concave-shaped brackets. Outer surfaces of the EMI brackets 252 are in contact with inner surfaces of the EMI cores 44, 45. Shapes of the EMI brackets 252 match a shape of the inner perimeters 124 of the EMI cores 44, 45.

The EMI brackets 252 may have an uncompressed state, a first compressed state, and/or a second compressed state. Average radii of an outer surface and/or outer perimeter of the EMI brackets 252 relative to the centers of the EMI cores 44, 55 may be greater than or equal to a radius of the inner perimeters 124 when the EMI brackets 252 are in an uncompressed state. Average radii of an outer surface and/or outer perimeter of the EMI brackets 252 relative to the centers of the EMI cores 44, 55 may be less than or equal to a radius of the inner perimeters 124 when the EMI cores 44, 45 are installed and the EMI brackets 252 are in the second compressed state. The EMI brackets 252 may be in the first compressed state during installation of the EMI cores 44, 45.

The EMI brackets 252 may be used in replacement of the EMI brackets 46 of FIGS. 1-3. The EMI brackets 252 are positioned in a center opening of the EMI cores 44, 45 and are disposed through the EMI cores 44, 45. Each of the EMI brackets 252 may include a center member 260 and a pair of flanges 262. Each outermost suspended member 261 of the busbars 66 and/or each of the outermost busbars 120, 122 may be disposed between respective pairs of the flanges 262 of a corresponding one of the EMI brackets 252. Innermost suspended members 264 (suspended members furthest away from the EMI cores 44, 45) of the busbars 66 and/or innermost ones of the busbars 66 may not be disposed between respective pairs of the flanges 262.

Each of the flanges 262 includes a first angled section 270, a first member 272, a second angled section 274, and a second member 276. The first member 272 extends at a first angle α from the center member 260 and towards the centerlines 146 of each of the EMI cores 44, 45. The first angle α is provided by the first angled section 270. The second member 276 extends at a second angle β from the first member 272 and away from the centerlines 146. The second angle β may be greater than the first angle α. The second angle β is provided by the second angled section 274.

The EMI brackets 252 may be formed of, for example, polycarbonate resin thermoplastic and/or other suitable materials. The EMI brackets 252 may be formed of insulative, transparent and/or non-conductive materials. The EMI brackets 252 may be non-conductive.

The flanges 262 are in an uncompressed state prior to installation of the EMI cores 44, 45 on the EMI brackets 252. The EMI brackets 252 may be compressed to rotate the flanges 262 towards each other, towards the centerlines 146 and away from the EMI cores 44, 55 to a first compressed state during installation of the EMI cores 44, 45. Once the EMI cores 44, 45 are installed, the flanges 262 may be released to a second compressed state or to the uncompressed state. Although not shown in FIGS. 11 and 12, the EMI brackets 252 may include compression slots, similar to the compression slots 152, 176 shown in FIGS. 6-7, which may be used to compress the EMI brackets 252 to the first compression state.

When installed, all of the busbars 66 may be disposed between the EMI brackets 252. The EMI brackets 252 are pressed between the EMI cores 44, 45 and the outermost busbars 120, 122. The flanges 262 may extend over the outermost busbars 120, 122.

The EMI brackets 252 may include holes for insertion of threaded rods 280 or other suitable fasteners for fastening spacers (spacers 282 are shown) and the busbars 66 similar to that described with respect to the EMI brackets 102, 104, the busbars 66, and the spacers 112 of FIG. 4. As shown, the busbars 66 are connected to each other and the EMI brackets 252 via fasteners and spacers. Each of the fasteners may include a first element (e.g., a threaded rod) and second elements (e.g., nuts and/or washers). For example only, during installation, two threaded rods are pushed through respective holes in the busbars 66, the EMI brackets 252 and the spacers including the spacers 282. The washers are then slid onto the threaded rods. The nuts are then screwed onto the threaded rods. The nuts may be screwed onto the threaded rods to satisfy predetermined torque settings.

The threaded rods may each be covered with an insulating tube (not shown). The insulating tube may be slid over the threaded rods. The threaded rods and corresponding insulating tubes may be slid through the respective holes in the busbars 66, the EMI brackets 252, and the spacers prior to installing the washers and the nuts on the threaded rods. The insulating tubes may isolate and/or prevent contact between the busbars 66 and the threaded rods. As an alternative to using the insulating tubes, the threaded rods may be coated or rapped with an insulating material. As an example, the threaded rod may be formed of stainless steel and/or other suitable materials.

The spacers may be located between the busbars 66 and on each side of each of the busbars 66 including the outermost busbars 120, 122. The spacers may be, for example, washers formed of fiberglass reinforced polyester and/or other suitable insulative and/or non-conductive materials.

The above-described EMI brackets suspend and protect the corresponding EMI cores, which are mounted on the EMI brackets. Although certain mounting techniques are shown, other techniques may be used to mount the EMI brackets on the busbars and/or to mount the EMI cores on the EMI brackets. The EMI brackets prevent the EMI cores from coming in contact with busbars of an UPS during faults in utility supplied AC power. The EMI brackets in flexion create a suspension system for the EMI cores, where the suspension system accommodates busbar movement during a utility power fault. The EMI brackets also shield and protect the busbars from coming in contact with pieces of a broken EMI core. The EMI brackets cover busbars and prevent pieces of an EMI core from falling and contacting and/or shorting one or more busbars to other busbars and/or other electrical and/or conductive components of an UPS. The structure, geometries, and makeup of the EMI brackets including the material (or materials) of the EMI brackets and the connection of the EMI brackets to the busbars and the cores allows the EMI brackets to flex and constrain the busbars and the cores.

During installation, the above-described EMI cores may be snapped into place on the EMI brackets. The EMI brackets cradle and may center the EMI cores on the busbars that the EMI cores surround.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); a discrete circuit; an integrated circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be partially or fully implemented by one or more computer programs executed by one or more processors. The computer programs include processor-executable instructions that are stored on at least one non-transitory tangible computer readable medium. The computer programs may also include and/or rely on stored data. Non-limiting examples of the non-transitory tangible computer readable medium include nonvolatile memory, volatile memory, magnetic storage, and optical storage.

What is claimed is:

1. An electromagnetic interference (EMI) filter assembly comprising:
an EMI core comprising a center opening and configured to prevent interference between busbars of an uninterruptible power supply, wherein the EMI core surrounds members of the busbars;
at least one bracket disposed though the center opening and configured to hold the EMI core to the busbars, wherein the at least one bracket comprises a plurality of flanges, and wherein the plurality of flanges comprise slots in which the EMI core is held;
spacers disposed between the busbars; and
fasteners that connect the at least one bracket, the spacers, and the busbars to each other.

2. The EMI filter assembly of claim 1, wherein the at least one bracket includes only a single bracket.

3. The EMI filter assembly of claim 2, wherein the single bracket comprises:
a center member disposed between a first two of the busbars and a second two of the busbars;
a first flange that extends over the first two of the busbars; and
a second flange that extends over the second two of the busbars.

4. The EMI filter assembly of claim 3, wherein the first flange and the second flange:
are on opposite sides and opposite ends of the center member; and
extend away from the center member in opposite directions.

5. The EMI filter assembly of claim 3, wherein:
the first flange comprises
a first member, and
a second member; and
the second flange comprises
a third member, and
a fourth member.

6. The EMI filter assembly of claim 5, wherein:
the slots comprise a first slot and a second slot;
the first member and the second member provide the first slot;
the third member and the fourth member provide the second slot; and
the EMI core is held in the first slot and the second slot.

7. The EMI filter assembly of claim 5, wherein:
the first flange comprises
a first angled section between the center member and the first member, and
a second angled section between the first member and the second member; and
the second flange comprises
a third angled section between the center member and the third member, and
a fourth angled section between the third member and the fourth member.

8. The EMI filter assembly of claim 7, wherein:
the at least one bracket has an uncompressed state and a first compressed state;
the first flange is configured to rotate towards the center member via the first angled second and the second angled section when being transitioned from the uncompressed state to the first compressed state; and
the second flange is configured to rotate towards the center member via the third angled second and the fourth angled section when being transitioned from the uncompressed state to the first compressed state.

9. The EMI filter assembly of claim 8, wherein:
the EMI bracket is configured to be in a second compressed state;
the first flange and the second flange are in the first compressed state during installation of the EMI core on the at least one bracket; and
the first flange and the second flange are in the second compressed state subsequent to installation of the EMI core on the at least one bracket.

10. The EMI filter assembly of claim 1, wherein the at least one bracket comprises:
a first bracket; and
a second bracket,
wherein the first bracket and the second bracket are outward facing brackets such that center members of the first bracket and the second bracket pass through a center of the EMI core.

11. The EMI filter assembly of claim 10, wherein:
the first bracket comprises a first plurality of flanges;
the second bracket comprises a second plurality of flanges; and
the first plurality of flanges extend from the center member and in an opposite direction as the second plurality of flanges.

12. The EMI filter assembly of claim 11, wherein:
the spacers comprises
first spacers disposed on an outermost side of a first busbar, and
second spacers disposed on an outermost side of a second busbar;
the first plurality of flanges extend over a first pair of the busbars and are in contact with the first spacers; and
the second plurality of flanges extend over a second pair of the busbars and are in contact with the second spacers.

13. The EMI filter assembly of claim 11, wherein:
members of a first two of the busbars are disposed between the first plurality of flanges; and
members of a second two of the busbars are disposed between the second plurality of flanges.

14. The EMI filter assembly of claim 11, wherein:
each of the first plurality of flanges and each of the second plurality of flanges comprises a compression slot;
the first plurality of flanges are rotated toward each other via respective ones of the compression slots; and
the second plurality of flanges are rotated toward each other via respective ones of the compression slots.

15. The EMI filter assembly of claim 1, wherein the at least one bracket comprises:
a first bracket; and
a second bracket,
wherein the first bracket and the second bracket are inward facing brackets such that all of the busbars are disposed between the first bracket and the second bracket.

16. The EMI filter assembly of claim 15, wherein:
the first bracket comprises a first plurality of flanges;
the second bracket comprises a second plurality of flanges; and
the first plurality of flanges extend from a center member of the first bracket and towards the second plurality of flanges.

17. The EMI filter assembly of claim 16, wherein:
outermost ones of the busbars are disposed respectively between the first plurality of flanges or the second plurality of flanges; and
innermost ones of the busbars are not disposed between the first plurality of flanges or between the second plurality of flanges.

18. The EMI filter assembly of claim 1, wherein each of the fasteners comprises an element that extends through the at least one bracket, the busbars, and the spacers.

19. The EMI filter assembly of claim 1, wherein the at least one bracket prevents the EMI core from contacting the busbars and allows the EMI core to move with the busbars.

20. An electromagnetic interference (EMI) bracket comprising:
a center member comprising holes for attaching fasteners to connect the EMI bracket to busbars of an uninterruptible power supply; and
a plurality of flanges configured to hold an annular-shaped EMI core on the busbars,
wherein the center member and the plurality of flanges prevent the annular-shaped EMI core from contacting the busbars and allow the annular-shaped EMI core to move with the busbars.

21. The EMI bracket of claim 20, wherein the plurality of flanges comprise:
a first flange comprising
a first member, and
a second member,
wherein the first member and the second member provide a first slot; and
a second flange comprising
a third member, and
a fourth member,
wherein the third member and the fourth member provide a second slot, and
wherein the first slot and the second slot are configured to hold the annular-shaped EMI core.

22. The EMI bracket of claim 21, wherein:
the first flange comprises
a first angled section between the center member and the first member, and
a second angled section between the first member and the second member; and
the second flange comprises
a third angled section between the center member and the third member, and
a fourth angled section between the third member and the fourth member.

23. The EMI bracket of claim 22, wherein:
the EMI bracket has an uncompressed state and a first compressed state;
the first flange is configured to rotate towards the center member via the first angled second and the second angled section when being transitioned from the uncompressed state to the first compressed state; and
the second flange is configured to rotate towards the center member via the third angled section and the fourth angled section when being transitioned from the uncompressed state to the first compressed state.

24. The EMI bracket of claim 23, wherein:
the EMI bracket is configured to be in a second compressed state;
the first flange and the second flange are in the first compressed state during installation of the annular-shaped EMI core on the at least one bracket; and
the first flange and the second flange are in the second compressed state subsequent to installation of the annular-shaped EMI core on the at least one bracket.
